(19) United States
(12) Patent Application Publication
(10) Pub. No.: US 2002/0004418 A1
(43) Pub. Date: Jan. 10, 2002

(54) Grain harvesting device

(75) Inventors: Cezar de Mello Mesquita, Londrina (BR); Rogerio Cruz Moreira, Londrina (BR)

Correspondence Address: SMITH, GAMBRELL & RUSSELL, LLP, ATTORNEYS AT LAW, SUITE 800, 1850 M STREET, N.W., WASHINGTON, DC, 20036, US

(73) Assignee: Rota Industria de Maquinas Agricolas Ltda.

(21) Appl. No.: 09/832,302

(22) Filed: Apr. 11, 2001

Related U.S. Application Data
(63) Continuation-in-part of application No. 09/442,634, filed on Nov. 18, 1999, now abandoned.

(51) Int. Cl. A01D 87/10; A01D 45/30; A01B 59/043

(52) U.S. Cl. 460/115; 56/12.7; 56/126; 460/135; 172/439; 56/13.3

(57) ABSTRACT

The object of this Patent comprises the action of flexible nylon cords (3), spirally attached in parallel axis (2), rotating one opposed to the other, producing pounding impacts on the standing uncut plants in the field.

Such impacts carry enough energy to release the seeds by shattering the pods in small fragments. Both seeds and pod fragments are processed by the components of the pneumatic system specially designed to accomplish the operations complementary to threshing such as: separation of grain and straw, collecting, transporting, and cleaning of grain.

The separation of grains and straw is achieved by the state of suspension provided to the straw by the air flow from the fan (9) through the air outlets (13) of the upper air duct (21), whereas the seeds, due to their weight, fall externally on a sloped surface of the upper air duct (21) and, from there, slide by gravity towards the venturi-shaped receptacle (8) where they are conveyed into and throughout the duct (17) to the reservoir (8).

The device is modular, considering that the parallel axis (2) will be projected to harvest one, two, three, four, five or six row of plants, according to the harvest design, and the size of the crop area. This characteristic and the fact it is coupled to tractors three-point hitch, make it suitable for small- and medium-sized crop areas.

### BACK GROUND OF TIE INVENTION

1. Field of the Invention

This invention relates to agricultural machines field, specifically to grain harvesting equipment, referring to a unique grain harvesting device which, driven by the power take off shaft and coupled to the three point hitch of regular tractors, is more suitable to small and medium sized crop areas; thus simplifying and lowering the costs of harvesting operation by threshing, notably soybeans, directly from the standing, uncut plants in the field, by imparting mechanical impact to the pods with flexible cords fixed on opposite rotating shafts, and by collecting the seeds through a pneumatic system.

2. Description of the Prior Art (STATE OF THE ART)

Harvesting is the most critical operation in most crops. The simultaneity of the various operations performed by machines in grain harvesting make the use of these complex equipments very costly. Such operations, basically characterized by cutting, conveyance, collection, transportation, threshing, separation, cleaning, elevation, and storage of grain material are performed by distinct mechanisms, the conjugated action of which further requires other interconnection structural components.

On the other hand, the use of combines to harvest soybeans has been the subject of studies more concerned with the improvement of components to reduce the amount of grain left on the ground and to increase harvesting capacity than with any major changes in the combine's functional characteristics which would simplify the original designs and reduce operation costs. Consequently, the growing demand for soybeans has contributed to an increase in machine size, energy consumption and operational expenditure, making harvesting one of the highest input costs required for producing soybeans. Although there have been a few revolutionary changes over the last 70-plus years, most combines still retain all of the original functional characteristics such as the tangentially fed threshing cylinder and concave, patented over 200 years ago. However, either tangentially or axial fed threshing devices process the entire soybean plant, including stalks and pods, while research has shown that this threshing process to be the main source of energy inefficiency. The operational characteristics of existing combines require the entire crop to be cut before being threshed, separated and cleaned. New designs introduced into the U.S. and Europe indicate that a reduction in processing of MOG is a major factor contributing to the harvesting of higher quality beans, a more efficient use of energy, and a reduction in operating costs. This finding challenges researchers to design simpler and cheaper harvesters in which plants will not be cut, extracted from the field, and processed to collect their seeds.

Despite the fact that combines were not originally designed for soybeans, they performed successfully the first time they were used to harvest the crop more than 70 years ago. However, the dehiscence characteristic of soybean pods led most of the initial research carried out to improve combine header components to reduce the majority of seed losses resulting from pod shattering. The components were modified to reduce the impact on soybean pods and the height of cutting, leading to major advancements such as flexible header designs and the AHC (automatic height control) devices. About 20 years ago, the state-of-the-art in soybean harvest technology resulted in more than 90 patents on devices whose purpose was to reduce crop-gathering losses.

Concerning the threshing mechanism, most combines still use the conventional transverse cylinder and concave, the original idea having been patented over 200 years ago. The axial flow rotor threshing system was introduced into American combines approximately 25 years ago. This resulted in a major improvement, giving rise to combines which had a higher capacity and lower seed damage than the conventional transverse cylinder. However, the axial flow principle was patented in Germany over 100 years ago in 1886. According to research conducted in 1977, the principle aim of the threshing device must be to eliminate seed loss during the threshing process—in addition to reduce both macro and microscopic damage to the seeds—and, at the same time, carry out the separation of the grain. The research concluded that threshing was still far from being at a desirable level of efficiency. In order to maintain the peripheral speed when threshing entire soybean plants, both transverse threshing cylinders and axial rotors require a considerable amount of energy. In fact, researches carried out in 1976 and 1983 showed that threshing mechanism is the component of a harvester which most requires the power made available by the motor: Approximately 40% (forty percent). Paradoxically, some findings indicate that only a small amount of energy is necessary to shatter soybean pods. This contradiction could be explained by the fact that the threshing cylinder has to process the whole plant instead of only the pods.

In 1977, North-American design engineers declared that they needed more information on the physical-mechanical properties of the cultures in order to develop the technology required to build harvesters insensitive to changes in the cultures, or adaptable to those changes. Such information would help in the definition of a better treatment to be applied during harvest, in order to achieve expected results. The design engineer could then guess a mechanism to produce such a treatment. Among others, one of the most important properties required to project harvesters is the one that estimates the degree of difficulty or effort with which the seeds are released from the pods or stems. The quantification of the parameter was estimated in the studies made in 1972, 1974, and 1989, and associates the impact mechanical action with the dehiscence of the pods.

If the number of parts of a combine and the MOG (Material Other than Grain) passing through it are reduced, it is likely that the durability and reliability of the combine will increase, thus increasing product quality and reducing the energy demand, combine size, and operational costs. According to some researchers, reliability is achieved by simplification and improvement. Machines built of fewer parts have a head start toward achieving higher reliability, and improvement can be attained during the design or test phase by initially simplifying the design and then improving it as necessary. Both phases are required and both contribute equally to an increase in reliability. In view of this, new combine models and accessories, which reduce the stalk throughput, have been marketed in Europe, and revolutionary prototypes, with around 55% fewer moving parts than a conventional combine, have been developed in the United States.

About seven years ago, studies were carried out on the mechanics of soybean threshing based upon the idea of not extracting the plant from the field. Simulating the movement of an experimental unit over a row of soybean plants in the laboratory, experimental equipment was built to analyze the mechanical actions of impact on soybean plants. The result showed 97% threshing efficiencies with impact by a moving metal surface.

Another serious problem is the near nonexistence of equipment adapted to the harvest of small crops of a size, for example, up to 50 ha, which represent the majority of all soybean plantations. The high cost of the small sized harvesters, usually used for research plots, is also determined, practically, by the same number of systems or components characteristics of the regular harvesters. It must be observed that such components do not necessarily become cheaper by simply reducing their size.

Factors like these are among the most important limiting the expansion and exploration of soybeans and other crops in small- and medium-sized properties.

### SUMMARY OF THE INVENTION

This present invention refers to a grains harvesting device, such grains being notably soybean, and by means of which crop is threshed, in a unique way, from standing uncut plants by impact energy provided by flexible cords or threads, made of nylon, plastic or another substitute material, fixed on opposite rotating shafts, striking the soybean pods from both sides of the plant row. To assure the impact on the pods the threads are spirally attached along the parallel shafts, which are set at a descending angle of approximately 30° (thirty degrees) in relation to the ground line.

Said parallel shafts, upon the action of the threads attached thereto, promote an upward sweep of impacts on both sides of the plants, which, are guided between the parallel inclined axes during the displacement of the harvesting device over the plants row. The grains are released upon the impacts imparted to the pods, and conveyed to a receptacle point, by gravity. From that point, they are introduced, along with debris of straw, into a duct (pipe) and conveyed to a reservoir through a specially designed pneumatic system, which also performs the separation and elimination of the straw and remaining solid particles. This harvesting device is coupled to the three-point hitch of regular tractors and uses their p.t.o shafts to power its very few moving mechanisms. Therefore, it should be emphasized that it is more suitable for harvesting operation of small- and medium-sized crop areas.

The harvesting device, as herein described for harvesting soybeans and other grains, uses very few components, especially moving elements, which in a last analysis simplifies, and, thus, cheapens the harvesting operation due to the absence of practically all the regular mechanisms of a conventional harvester. The conjugated action of air jets and of the impacts produced by flexible threads on the pods, clusters or stems, releases, cleans, and conveys the grains to a receptacle, and, subsequently, to a reservoir.

### DESCRIPTION OF THE NEW FIGURES (DRAWINGS AND PICTURES)

A better understanding of the object hereof presupposes the awareness of the illustrations attached hereto, wherein:

FIG. 1 is a conceptual drawing view of the basic structure and threshing mechanism of the harvesting device's prototype.

FIG. 2 shows a picture featuring the overall front and rear views of the basic structure and threshing mechanism of the prototype detaching structural chassis, transmission system, three point hitch, p.t.o hitch, row dividers, twin shafts, and support/height adjustment wheel.

FIG. 3 is a picture detailing a close front view of the threshing mechanism's components such twin shafts, nylon cords, row dividers, driving pulleys, and support/height adjustment wheel.

FIG. 4 shows schematic drawing, side view, detaching soybean plants before and after being threshed.

FIG. 5 is a picture showing the first field test of the basic structure and threshing mechanism.

FIG. 6 shows a picture of partial sight of a soybean field comparing the row threshed by the prototype to unthreshed rows.

FIG. 7 is a picture of partial sight of a dryland rice crop comparing the row threshed by the prototype to unthreshed rows.

FIG. 8 highlights a picture of another field test of the prototype detaching an improvised threshing chamber and a small pan at the bottom, adapted to the structure to collect soybean seeds and MOG samples for analysis.

FIG. 9 is a picture of soybean seeds and MOG collected during field test of the basic structure and threshing mechanism of the prototype.

FIG. 10 is a conceptual left side drawing view of the complete harvesting device detaching mainly the components of the pneumatic system.

FIG. 11 shows a picture of the left side of the complete concept of the harvesting device being prepared for a field test for overall evaluation, adjustments and modification of its components.

FIG. 12 is a schematic drawing of the right side view of the complete concept of the harvesting device.

FIG. 13 features a picture of the right side of the complete concept of the harvesting device detaching the transparent wall of the threshing chamber which allows a visual evaluation of the dinamics of the threshing, cleaning, and seed collection processes.

FIG. 14 is a conceptual drawing of: 1—partial left side view of the upper air duct for blowing out the straw, bottom air duct for conveying grains, and venturi-shaped receptacle for capturing grains into the air conveying duct; 2—partial view, in perspective of the inlets of upper air duct for blowing the straw, bottom air duct for conveying grains; and venturi shaped receptacle for capturing grains into the air conveying duct.

FIG. 15 shows a conceptual drawing of the rear view detaching the openings for straw elimination, holes of the air duct for blowing out the straw, venturi-shaped receptacle, twin shafts, and vertical left side wall of the threshing chamber.

FIG. 16 is a picture of the left side of the harvesting device during field test detaching: the grain reservoir, air ducts for blowing out the straw and conveying grains, venturi-shaped receptacle for capturing grains into the air conveying duct, grain elevation duct, and transparent threshing chamber.

FIG. 17 shows a picture detailing the drop of grains from the enlarged elevation inclined duct (pipe) to the reservoir, through an improvised screen net to allow visualization of the proces during field test of the prototype.

FIG. 18 is a picture detailing the enlarged elevation inclined duct (or pipe) showing the elimination of debris (mostly pods fragments), eventually captured with seeds at the venturi shaped receptacle.

FIG. 19 shows a picture of the reservoir of the harvesting device, detaching the outlet.

FIG. 20 is a picture of a sample of soybean seeds and MOG (small pieces of stalks) collected from the reservoir during field test of the complete concept of harvesting device.

### DESCRIPTION OF THE PREFERRED EMBODIMENT

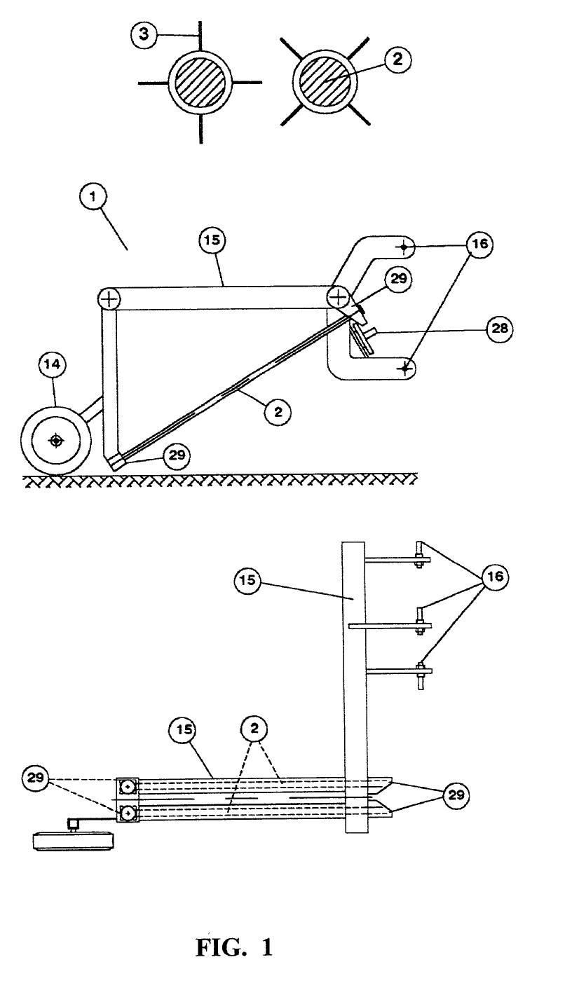

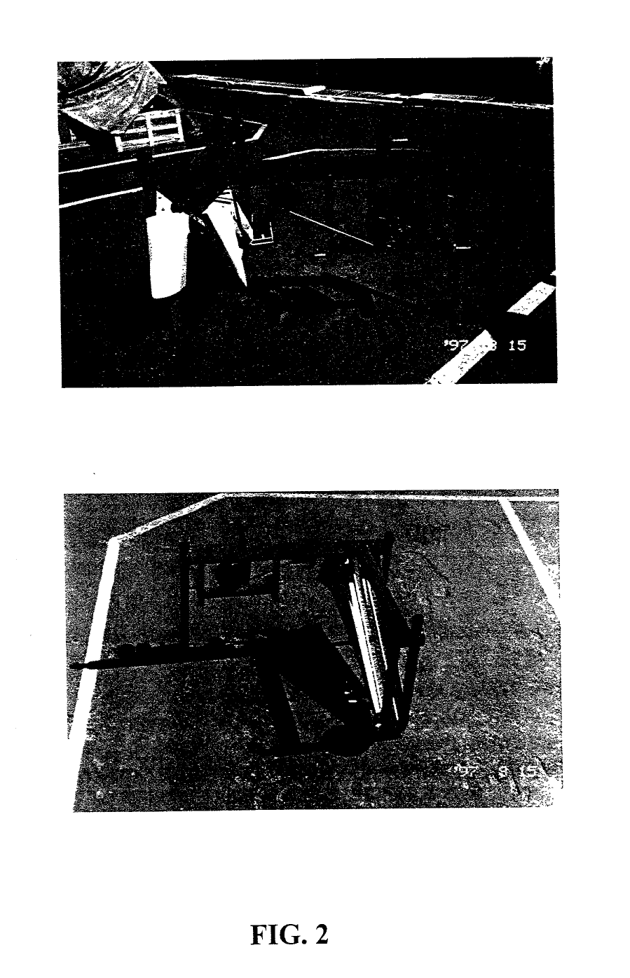

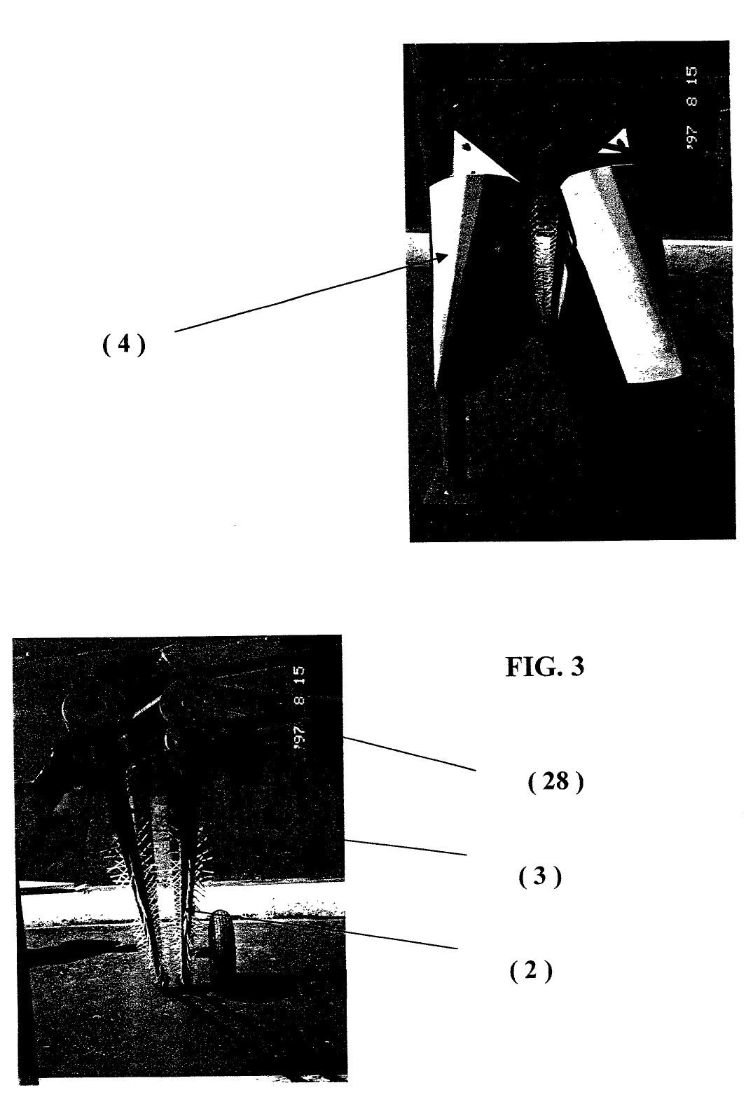

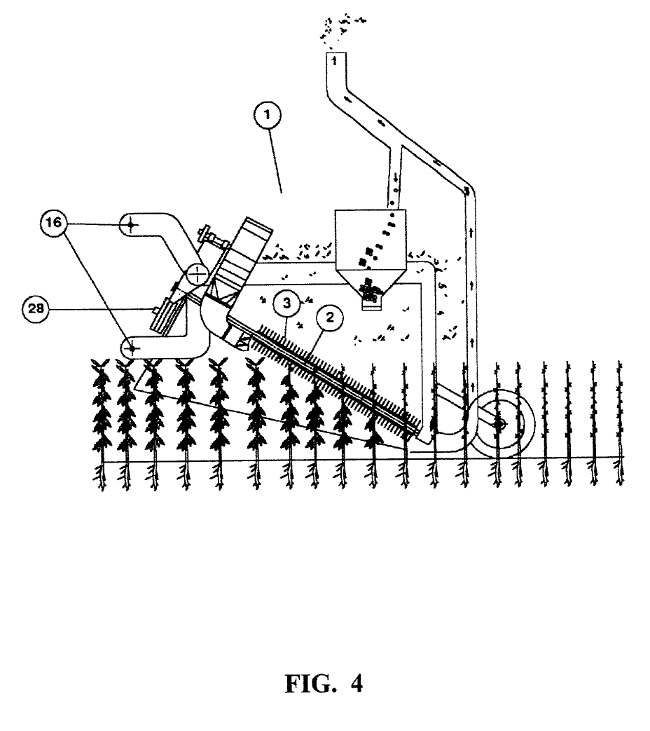

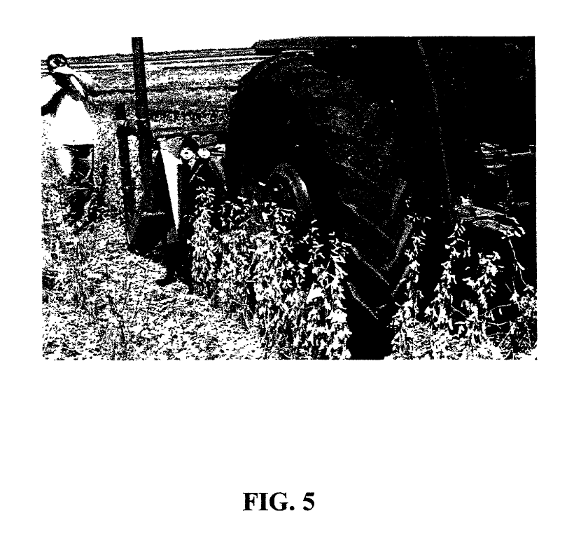

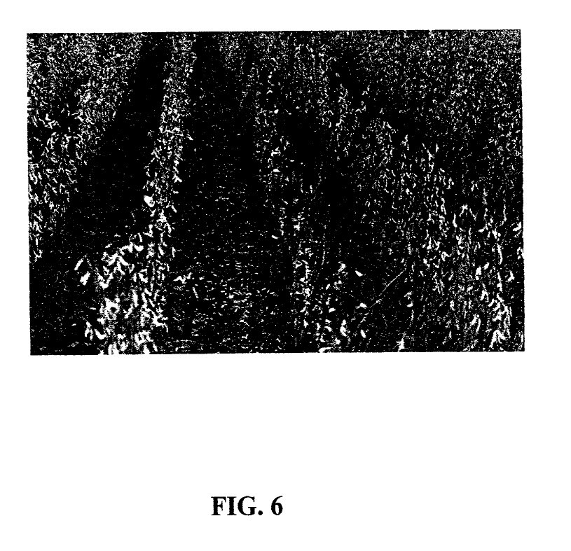

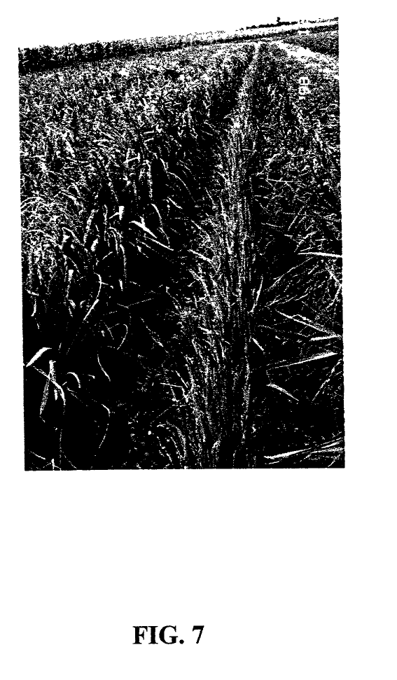

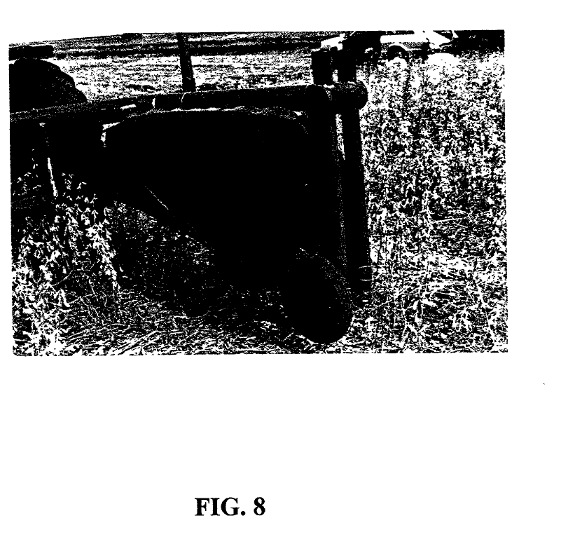

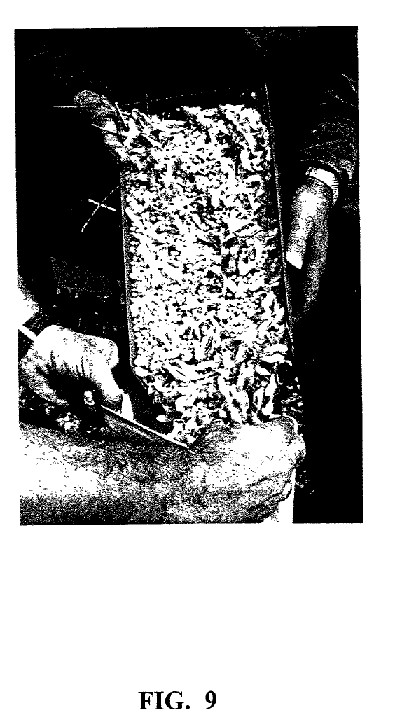

As illustrated in FIG. 1 and FIG. 2, the basic structure and the threshing system of the harvesting device is composed by a main flame or chassis (15), the three point hitch (16) and the driving pulley (28), a supporting wheel (14), which also allows the adjustment of the height of the action of the rotating twin shafts (2), and the nylon cords (3) fixed on them, to the ground level. The rotating shafts are connected to the main frame through four block bearing supports (29). FIG. 3 also shows a detailed front view of the twin shafts (2), nylon cords (3), row dividers (4), and shafts' driving pulleys (28). Like in all grain harvesters, the threshing system is also considered the heart or the main system of this new invention. However, unlike the others harvesters, this new threshing system is practically the only active mechanism (being active understood as moving mechanism or element in contact with the crop) of the entire harvesting device. Besides, the threshing mechanism is extremely simple as it is made of nylon cords (3) fixed on two parallel rotating shafts (2) driven by the tractor's power take off and assembled on a frame (15) connected to the tractor's three point hitch. The two rounded shafts were set 10 cm apart and at 30 degrees to ground level, inclining upwards from the back towards the front part of the prototype. Pieces of nylon cord, measuring 10 cm each and set 1 cm apart, were symmetrically fixed into holes drilled in the shafts following a spiral path. The shafts rotate in opposite directions at 2600 rpm creating an upward sweeping motion at both sides of the plant row, with the cords striking and shattering the pods. Row dividers were provided to ensure that plants remained in an upright position when introduced between the rotating shafts. FIGS. 4 and 5 detaches the way it works by showing the prototype being displaced along the row of soybeans in such way that the plants are naturally introduced between the two opposed parallel rotating shafts to be shattered. The upward sweeping motion of the cords and the shafts upward inclination ensure that all the pods existing along the plant stem are striked. The space between cords and the rotation of the shafts are also designed to assure that every pod is hit several times by the cords even with the harvesting device being displaced at ground speeds over 7 km/h. The impact of the nylon cords against the pods carries enough energy to easily shatter them, releasing the seeds. Therefore, this new harvesting device is able to thresh soybeans from standing, uncut plants showing a unique feature unlike any other harvester. It is important to emphasize that the simplicity of its design and the characteristic of being connected to the three-point hitch of regular tractors, make it suitable for small and medium areas sized crops. Therefore, considering its constructive characteristics, the device is modular, that is, it stands sets of two, four, six or more parallel axes, as it may be coupled to ordinary use tractors already available in small plantations. Besides, according to the convenience of the project, it may be mechanically or hydraulically driven, still using the tractor p.t.o or hydraulic system as the source to power the threshing and the blower of the pneumatic system. FIG. 6 and FIG. 7 show partial sights of soybean and dryland rice fields, respectively, comparing rows threshed by the harvesting device prototype to unthreshed rows, proving that is possible to collect the seeds without cutting the plants off the field to be threshed. FIG. 8 shows the left side view of the prototype detaching an improvised threshing chamber and a small pan at the bottom, both of them temporarily adapted to the basic structure to collect soybean seeds and MOG samples during field test for farther analysis. FIG. 9 pictures soybean seeds and MOG samples collected during field test for performance evaluation of the threshing mechanism detaching apparently good quality of seeds and the MOG, mostly composed by opened pods and pods fragments.

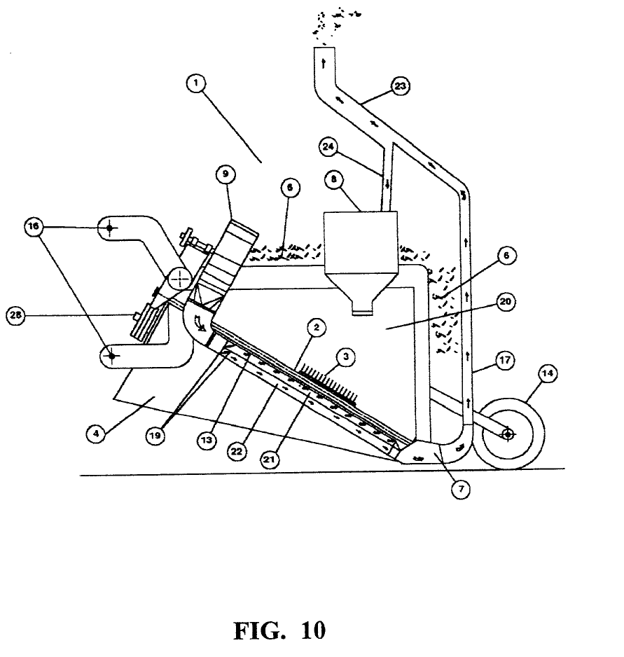

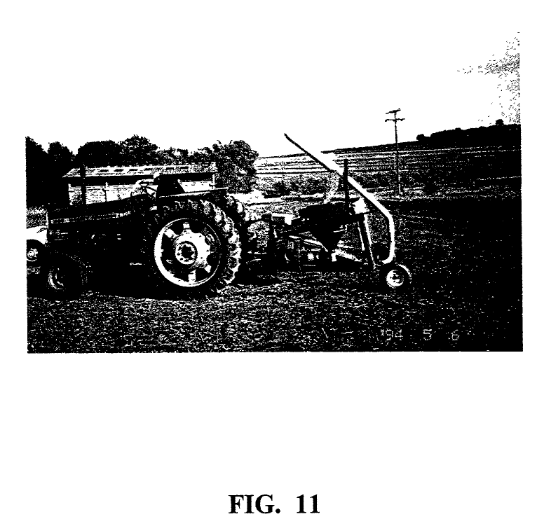

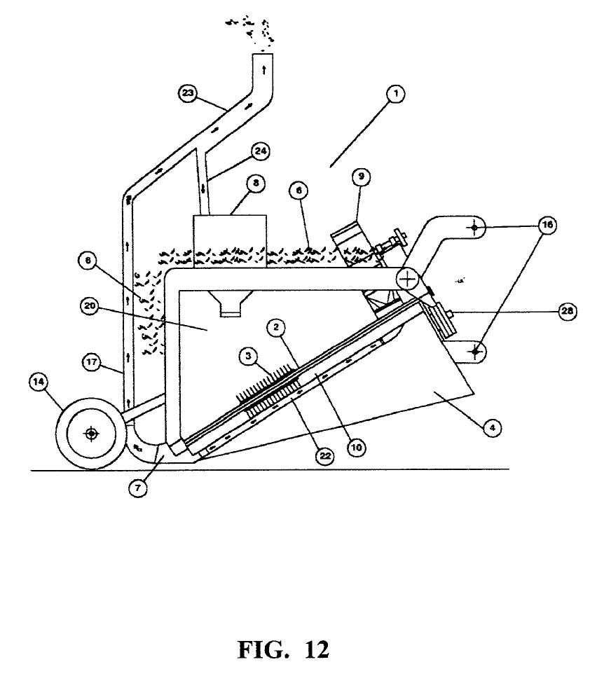

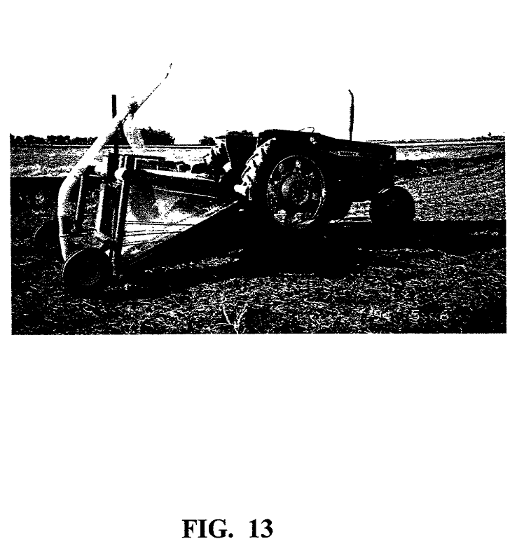

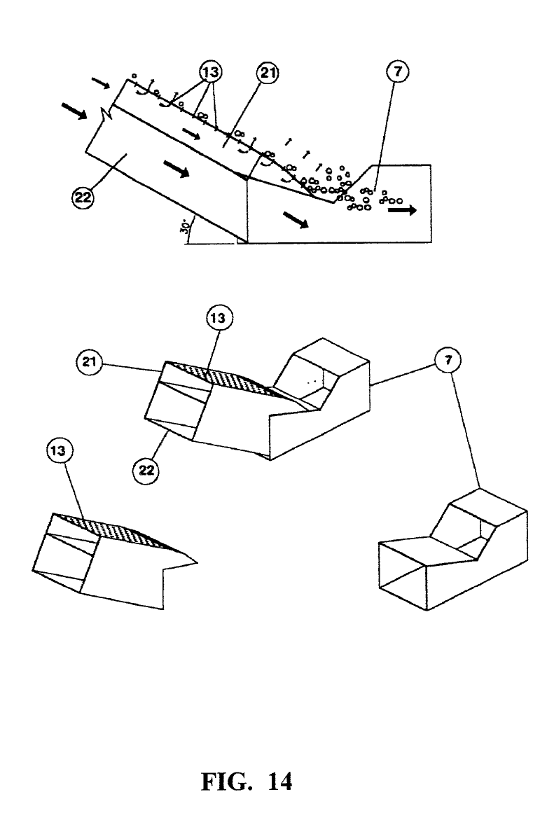

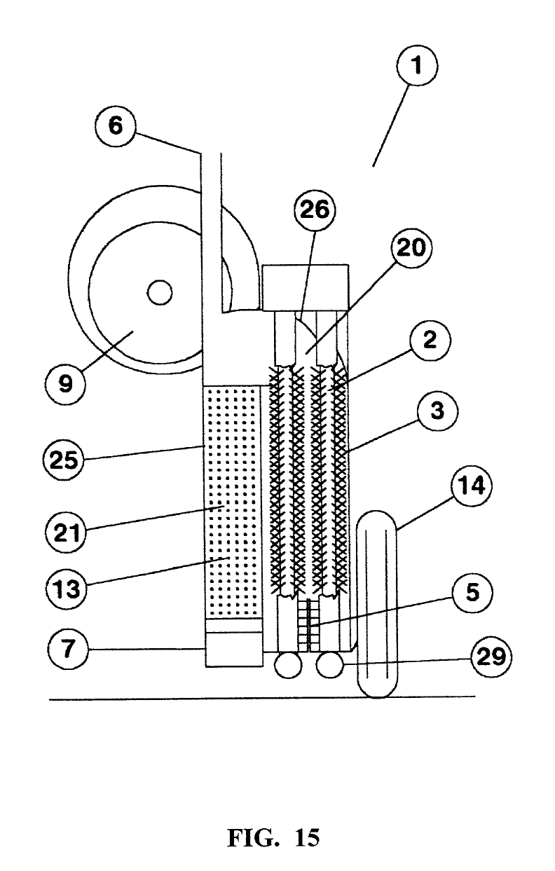

FIG. 10 presents the conceptual drawing and FIG. 11 pictures the left side view of the complete concept of the harvesting device, now including the components of the pneumatic system which performs all the other operations required by a grain harvester to complement threshing: separating grain and straw; capturing the grains; transporting (elevating) the grains; cleaning the grains; and storing the grains. The FIG. 10 detachs: the blower or fan (9); air regulation valves (19); upper air duct for blowing out the straw (21); air outlets or exit holes (13) of the upper air duct; bottom air duct (22) to transport or conveying grains; venturi shaped receptacle (7) to capture the grains into the air conveying duct (17); air conveying duct (17) to transport vertically the grains; inclined enlarged air conveying duct (23) to separate grains and debris of the straw eventually captured at the venturi shaped receptacle (7); improvised screen net (24), acting as grain returning duct, to allow visualization of the returning grains directing them to the grain reservoir (8). FIG. 12 and FIG. 13 show the right side view of the prototype detaching mainly the transparent threshing chamber (20), which allows the visualization of the dynamics of the threshing, separating, and grains capturing processes. FIG. 14 details, in conceptual drawings, the upper and bottom air ducts for separating straw and capturing and transporting grains, respectively, along with the venturi-shaped receptacle for capturing grains. FIG. 14 still shows perspective drawings of upper and bottom air ducts detaching the air outlets or exit holes of the upper air duct and the venturi-shaped receptacle. FIG. 15 shows a conceptual drawing of the rear view of the prototype detaching: the lateral upward/backward openings or exits (6), where the very most of the straw (MOG) is blown out from of the harvesting device; vertical left side wall of the threshing chamber (25); upper air duct (21) and its air outlets; venturi-shaped receptacle (7); rotating shafts (2); cords (3); threshing chamber (20); the right side curved (inclined) wall of the threshing chamber (26); and a rear curtain (5) to prevent seeds to be thrown out through the rear exit.

The pneumatic system works the following way: in the action of being striken by the nylon cords (3), inside the threshing chamber (20), the shattered pods release the grains and the MOG (mostly pods and pods fragments), which are thrown upwards and sidewards at different directions. Some grain will tend to fall back through the spaced cords of the rotating shafts. However, the slope of the shafts to the ground and their opposite rotate motion create a dynamic wall which prevent the grain or MOG material to fall back towards the ground. A half gutter pipe, underneath each shaft, also prevents tha fall of seeds towards the soil ground. Grain hitting the right curved wall (26) of the threshing chamber will bounce toward the opposite vertical wall (25) of the threshing chamber. This vertical wall (25) has a cushioned surface that absorbs the impact energy preventing the seeds to bouncing back toward the right curved wall (26). During the process of being projected directly from the cords strike (3), or indirectly by bouncing from the curved right wall (26) to the vertical left one (25), grains and MOG have to cross an invisible and continuous wall or column of air, supplied by the blower or fan (9), blowing upwards from the air outlets (13) of the upper air duct (21). This column of air blows parallel to the vertical wall (25) of the threshing chamber (20). The pressure and volume of the air column are adjusted through the air valve (19) to blow out only the straw, through the lateral upward/backward openings (6). Grains, which are considerably heavier than the straw, fall down by gravity on the surface of the upper air duct (21), despite the column of air being blown upwards from the air outlets (13). The inclined surface of the upper air duct (21) forces grains to slide down towards the venturi shaped receptacle (7) where they are sucked into the air duct (17). The bottom air duct for conveying grains (22) receives the air from the blower (9) and delivers it to the duct for grain transportation (17), through the venturi shaped receptacle (7). This piped air, which pressure and volume is also adjusted through another valve (19) similar to the one of the upper air duct (21), transport grains and debris of straw (mostly pods fragments) through the inclined elevation duct (or pipe), which is sharply enlarged (23) right above the reservoir (8). The enlargement of the pipe (23) causes a sudden reduction of the air pressure and velocity inside of it, turning them lower than the pressure and velocity necessary to keep the grains in upward motion. By reaching this pipe enlargement section, grains change direction going downwards to the reservoir (8), through the improvised screen net (24). On the other hand, the fragments of pods, which are eventually captured at the venturi (7) along with the grams, are not heavy enough to withstand the drop of air pressure and velocity at the enlargement section of the pipe (23) and, therefore, are blown out at the outlet of the enlarged pipe. Grains stricken by the cords tending to be thrown out at the rear end of the prototype will hit a curtain (5) set between the two vertical frames, molded in a material that does not offer resistance to the passage of plants, but prevent the grains from being thrown from the harvester, retaining them so as they fall by gravity and are directed to the venturi-shaped receptacle.

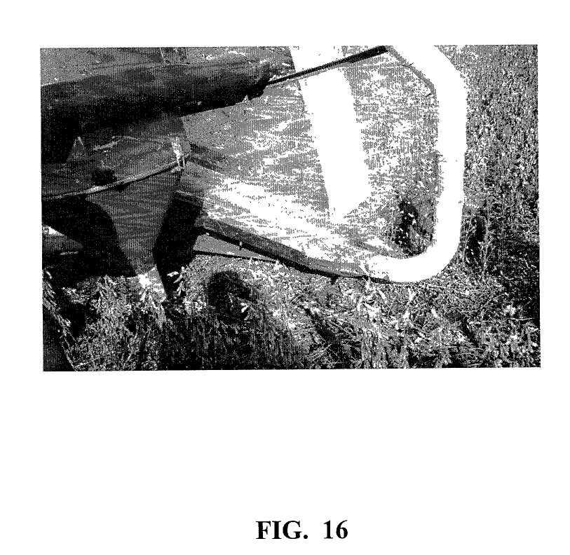

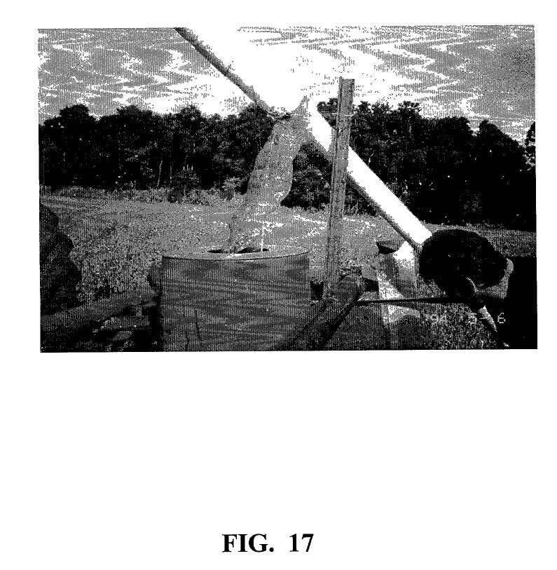

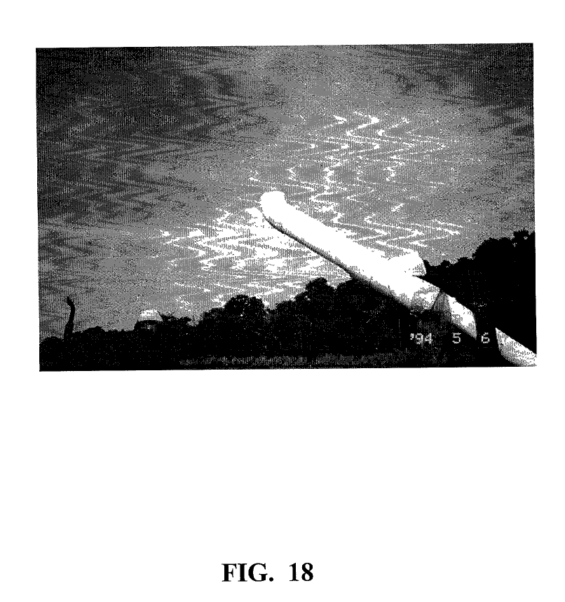

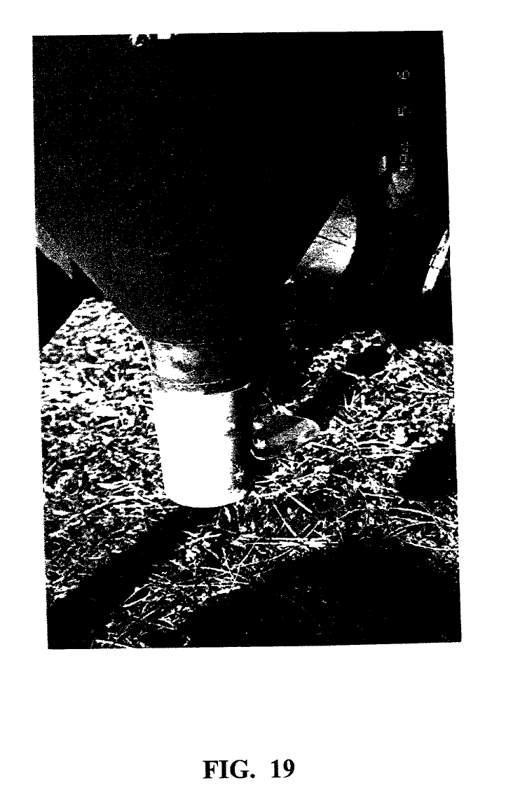

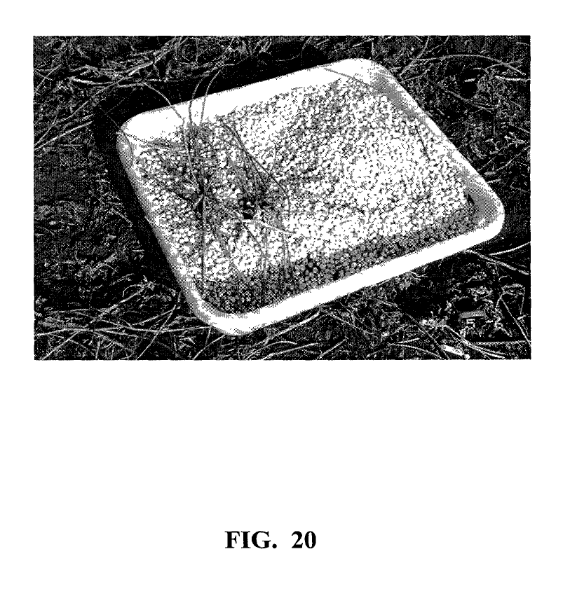

FIG. 16 pictures a partial left side view of the harvesting device prototype detaching the reservoir, the upper and bottom air ducts, the transparent threshing chamber, the venturi shaped receptacle, and the air duct to transport (elevate) grains, during a field test. FIG. 17 shows a picture highlighting the return of grains from the enlarged section of transporting pipe, through the screen net, during a field test. FIG. 18 features the enlarged section of the grain-transporting pipe, detaching the fragments of soybean pods being blown out through its outlet. FIG. 19 shows a partial view of the reservoir and its discharge outlet. FIG. 20 pictures a view of soybean seeds and MOG (small pieces of stalks) collected from the reservoir during field test of the complete concept of the harvesting device prototype.

The improved harvesting device has a very simple functional design which eliminates most of the movable mechanisms responsible for the innumerous simultaneous operations which characterize the ordinary use harvesters.

In addition, the harvesting performance during field tests has presented high efficiency concerning threshing percentage and very low rates of broken grains and MOG removal. The average rate of pod threshing was higher than 97% and the seed-breaking rate was lower than 0.4%.

The rational utilization and the low requirement of power available by the tractor's engine for the harvesting operation also characterize the device being described.

Consequently, substantial reductions in the price of the harvester and its operation costs are expected through the use of the simplified characteristics of the machine and of the modular concept which allows the equipment to be prepared to harvest different numbers of rows according the size of the crop area.

Having thus described the invention, what is claimed is:

1. IMPROVED GRAIN HARVESTING DEVICE (1) comprising a threshing mechanism, to thresh grains out of the pods directly from uncut plants in the field, and a pneumatic system to separate grain and straw, transport, clean, and store the grain, said improved grain harvesting device (1), characterized by a modular constructive concept which is connected to three point hitch and uses the p.t.o. shaft of conventional tractors to power, whether by mechanical or hydraulic means, the unique threshing mechanism and the pneumatic system, both of them constituting the entire harvesting device, said unique threshing mechanism, being practically the only active mechanism of the entire harvesting device, is made of nylon cords (3) fixed on two parallel rotating shafts (2) assembled on a frame (15) by block bearings support (29), are driven by the tractor's power take off and coupled to the tractor's three-point hitch, being the said shafts (2), set 10 cm apart and inclined upwards at 30 degrees to ground level, from the back towards the front part of the prototype, carrying pieces of nylon cords (3), measuring 10 cm each and set 1 cm apart, symmetrically fixed into holes drilled, according a spiral path, in the said shafts (2) each one having a half gutter pipe (10) underneath; said shafts (2) rotating in opposite directions create an upward sweeping motion at both sides of the plant row, allowing the cords (3) to strike and shatter the pods from the plants introduced between them with the displacement of the harvesting device (1) over the row of plants, after being guided by row dividers (4) provided to ensure plants in upright position when introduced between the rotating shafts (2); said rotating shafts (2) with their slope to the ground, the upward sweeping motion and the space between the cords (3) ensure every pod along the plant stem to be stricken several times, thus releasing the seeds; even with the harvesting device (1) being displaced at high ground speeds. Said threshing mechanism turns the improved grain harvesting device able to thresh soybeans from standing, uncut plants showing a unique feature unlike any other harvester.

2. IMPROVED GRAIN HARVEST DEVICE being also characterized by a pneumatic system, which said pneumatic system, performing all the other operations required to complement threshing, comprises a blower or fan (9) generating all the necessary air; air regulation valves (19) to adjust pressure and volume of air necessary along the system; upper air duct for blowing out the straw (21); air outlets or exit holes (13) of the upper air duct; bottom air duct (22) to transport or conveying grains; venturi-shaped receptacle (7) to capture the grains into the air conveying duct (17); air conveying duct (17) to transport vertically the grains; inclined enlarged air conveying duct (23) to separate grains and debris of the straw eventually captured at the venturi shaped receptacle (7); improvised screen net (24), acting as grain returning duct, to allow visualization of the returning grains directing them to the grain reservoir (8); said pneumatic system needs, to accomplish its function, complementary components which are assembled to the overall structure of the harvesting device (1) such: left side vertical wall (25) of the threshing chamber (20); right side curved wall (26); upward/backward openings (6); and rear curtain (5).
